(19) United States
(12) Patent Application Publication
(10) Pub. No.: US 2005/0265407 A1
(43) Pub. Date: Dec. 1, 2005

(54) Compact semiconductor-based chirped-pulse amplifier system and method

(76) Inventors: Alan Michael Braun, Lawrenceville, NJ (US); Peter J. Delfyett, Geneva, FL (US)

Correspondence Address: PLEVY & HOWARD, P.C., P.O. BOX 226, FORT WASHINGTON, PA, 19034, US

(21) Appl. No.: 11/130,038

(22) Filed: May 16, 2005

Related U.S. Application Data
(63) Continuation-in-part of application No. 10/859,553, filed on Jun. 1, 2004.
(60) Provisional application No. 60/571,355, filed on May 14, 2004.

(51) Int. Cl. H01S 3/10

(52) U.S. Cl. 372/30

(57) ABSTRACT

A compact signal source including: a semiconductor-based, pulsed optical energy source for providing a series of pulses at a given frequency; a selector being optical fiber coupled to the pulsed optical energy source and for down-selecting the pulses to a lower frequency; a stretcher being optical fiber coupled to the selector and for temporally stretching the selected pulses; at least one semiconductor-based optical amplifier being optical fiber coupled to the stretcher and for amplifying the selected pulses; a compressor being optical fiber coupled to the at least one semiconductor-based amplifier and for temporally compressing the amplified, stretched, selected pulses; and, a portable housing containing the pulsed optical energy source, stretcher, at least one semiconductor-based optical amplifier and compressor.

### RELATED APPLICATIONS

This Application claims priority of U.S. patent application Ser. No. 60/571,355, filed May 15, 2004, entitled COMPACT SEMICONDUCTOR-BASED CHIRPED-PULSE AMPLIFICATION SYSTEM, and is a continuation-in-part application of U.S. patent application Ser. No. 10/859,553, filed Jun. 1, 2004 entitled COMPACT, HIGH-POWER, LOW-JITTER, SEMICONDUCTOR MODELOCKED LASER MODULE, the entire disclosures of each of which are hereby incorporated by reference as if being set forth in their respective entireties herein.

### GOVERNMENT RIGHTS

This invention was made with Government support under Contract No. MDA-972-03-C-0043 awarded by DARPA. The Government has certain rights in this invention.

### FIELD OF INVENTION

The present invention relates generally to optical systems, and more particularly to photonic systems.

### BACKGROUND OF THE INVENTION

Semiconductor-based optical sources are desired in many applications, due in part to their compact and transportable nature, high operating speeds, and relative low cost, for example. Optical pulse signals having energies in the nano-joule (nJ) and micro-joule (pJ) range may be particularly useful in microscopy, high frequency (e.g., THz) signal generation and/or micro-machining applications, for example. However, when generating and amplifying short optical pulses using semiconductor-based sources, optical peak intensities may conventionally be sufficiently high to cause significant nonlinear pulse distortion and/or damage or destroy the semiconductor gain medium.

There are applications that require, or would otherwise benefit from, a compact source of nJ or μJ-level, high repetition-rate, short duration (e.g., picosecond (ps)) optical pulses, such as material modification, non-thermal ablation, electromagnetic pulse directed energy, and others.

### SUMMARY OF INVENTION

A compact signal source including: a semiconductor-based, pulsed optical energy source for providing a series of pulses at a given frequency; a selector being optical fiber coupled to the pulsed optical energy source and for down-selecting the pulses to a lower frequency; a stretcher being optical fiber coupled to the selector and for temporally stretching the selected pulses; at least one semiconductor-based optical amplifier being optical fiber coupled to the stretcher and for amplifying the selected pulses; a compressor being optical fiber coupled to the at least one semiconductor-based amplifier and for temporally compressing the amplified, stretched, selected pulses; and, a portable housing containing the pulsed optical energy source, stretcher, at least one semiconductor-based optical amplifier and compressor.

### BRIEF DESCRIPTION OF THE FIGURES

Understanding of the present invention will be facilitated by consideration of the following detailed description of the preferred embodiments taken in conjunction with the accompanying drawings, wherein like numerals refer to like parts and:

FIG. 1 illustrates a block-diagrammatic representation of a system according to an aspect of the present invention;

FIG. 2 illustrates signal processing according to an aspect of the present invention;

FIG. 3 illustrates a block-diagrammatic representation of a system according to an aspect of the present invention;

FIG. 4 illustrates a graphical representation of output signal intensity versus wavelength for a system according to an aspect of the present invention;

FIG. 5 illustrates a graphical representation of output signal intensity versus time for a system according to an aspect of the present invention;

FIG. 6 illustrates a graphical representation of a system configuration according to an aspect of the present invention; and,

FIG. 7 illustrates a graphical representation of a device according to an aspect of the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for purposes of clarity, many other elements found in typical optical systems and methods of making and using the same. Those of ordinary skill in the art will recognize that other elements are desirable and/or required in order to implement the present invention. However, because such elements are well known in the art, and because they do not facilitate a better understanding of the present invention, a discussion of such elements is not provided herein.

According to an aspect of the present invention, chirped pulse amplification (CPA) may be used in combination with a semiconductor-based (e.g., diode) laser source to provide a high peak power, short duration optical pulse generating laser system. CPA may be used to provide high peak power laser pulses by temporally stretching (chirping) ultrashort pulses prior to amplification. This effectively reduces the peak power to an acceptable level so as to efficiently extract energy from an optical amplifier without damaging the gain material. After amplification, the chirp is removed and the signal temporally re-compressed to provide short duration, high-power pulses. Typically low-gain solid state gain media are utilized with upper-state lifetimes much greater than the stretched pulse duration. Multi-pass amplifier systems are utilized to extract optical energy, resulting in large-scale laser systems.

According to an aspect of the present invention, semiconductor based, high efficiency, high gain, compact amplifiers may be used in combination with extreme CPA (x-CPA) techniques to provide a stretched pulse that is longer than the upper-state lifetime, such that energy extraction beyond the saturation energy can be achieved. X-CPA is a variant on CPA technique, in which high-gain short upperstate lifetime diode amplifier is utilized as the gain media. X-CPA is discussed in “X-CPA (extreme chirped pulse amplification)—Beyond The Energy Storage Limit Of Semiconductor Gain Media”, by Kyungbum Kim, Shinwook Lee, Delfyett, P. J., Jr., Lasers and Electro-Optics, 2004, (CLEO), ISBN: 1-55752-777-6, the entire disclosure of which is hereby incorporated by reference herein. Briefly, pulse stretching is used mainly for high energy extraction as the stretched pulse duration is longer than the upper-state lifetime, allowing pulse amplification over many lifetimes. Further, if pulse repetition rate is such that stretched pulses nearly overlap, utilized semiconductor amplifier experience CW as opposed to pulsed optical injection.

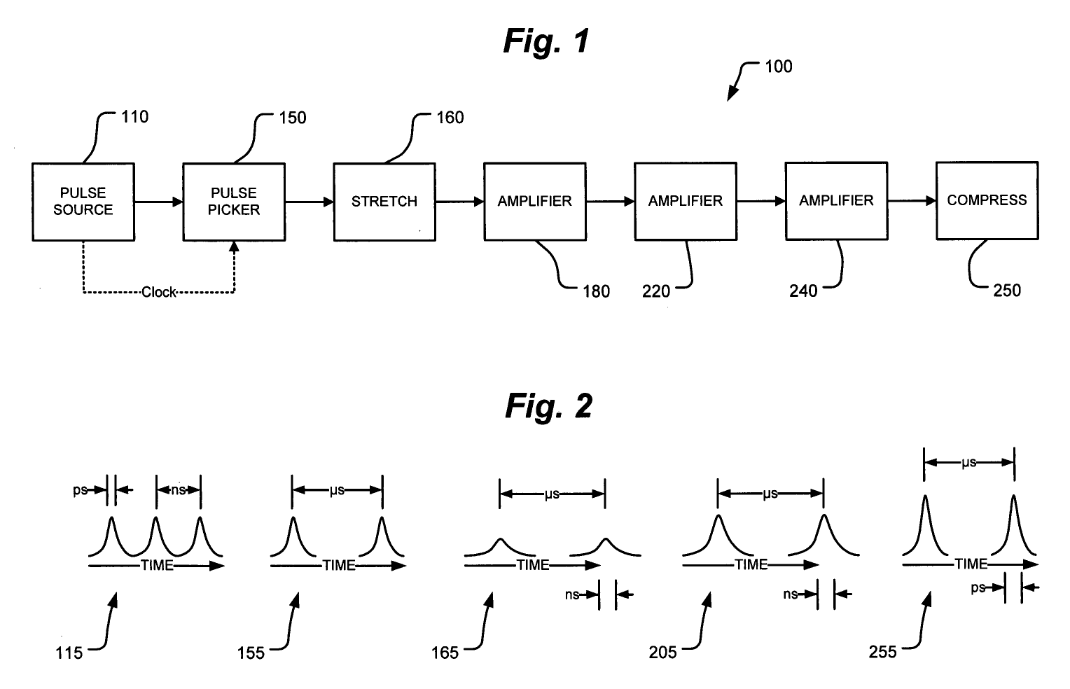

Referring now to FIG. 1, there is shown a system 100 according to an aspect of the present invention. System 100 generally includes an in-line source and X-CPA system, and may be packaged in a compact enclosure, such as an enclosure having an interior volume of less than about 1500 cubic inches (in³), for example.

More particularly, the illustrated system 100 includes an actively locked, high-frequency mode-locked laser (MLL) source 110 (that may provide a pulse-train on the order of about 1 GHz or higher), a pulse selector 150 (that may down-select the pulse-train to be on the order of about 1.5 MHz), a fiber Bragg grating (FBG) stretcher 160 (that may provide temporal pulse stretching on the order of about 500 ps/nm), cascaded pulse-bias semiconductor optical amplifiers (SOAs) 180, 220, and a FBG compressor 250 (that may provide temporal pulse compression pulse stretching on the order of about −500 ps/nm). Such as system may produce 10 pJ, 50 ps pulse trains with a 1 MHz repetition rate, for example. Pulse energies of 10 nJ or higher energies may be achievable by incorporating an Erbium Doped Fiber Amplifier (EDFA) 240 prior to compressor FBG 250, for example. Elements 110, 150, 160, 180, 220 (optionally 240) and 250 may be communicatively coupled together using polarization maintaining (PM), single-mode optical fiber patch cables, for example.

Referring now to FIG. 2, there is shown a series of graphical representations of signals that may be processed according to an aspect of the present invention. More particularly, source 110 may provide a signal 115 having a plurality of pulses of about 1 ps duration and at a 1 pulse/ns repetition rate. Pulse selector 150 may down-convert signal 115 to provide a signal 155 having a plurality of pulses at an about 1 pulse/ps repetition rate. Stretcher 160 may temporally stretch each of the pulses of signal 155 to have a duration of about 1 nsec or greater in signal 165. Amplifiers 180, 220 (and optionally 240) may amplify signal 165 to provide amplified pulse containing signal 205. Finally, FBG compressor 250 may temporally recompress the amplified pulses of signal 205 to have a duration on the order of about 1 psec or less in signal 255, thus converting the amplification energy into higher-peak, shorter duration pulse envelopes.

As will be understood by those possessing an ordinary skill in the pertinent arts, the example of FIG. 2 is for non-limiting purposes of explanation only. Pulses of other durations may be effectively used. For example, signal 115 may include pulses having fs to ps durations. Signal 155 may include pulses having ns to ps durations. Signal 165 may include pulses having durations greater than a ns. And, signal 255 may include pulses having fs to ps durations.

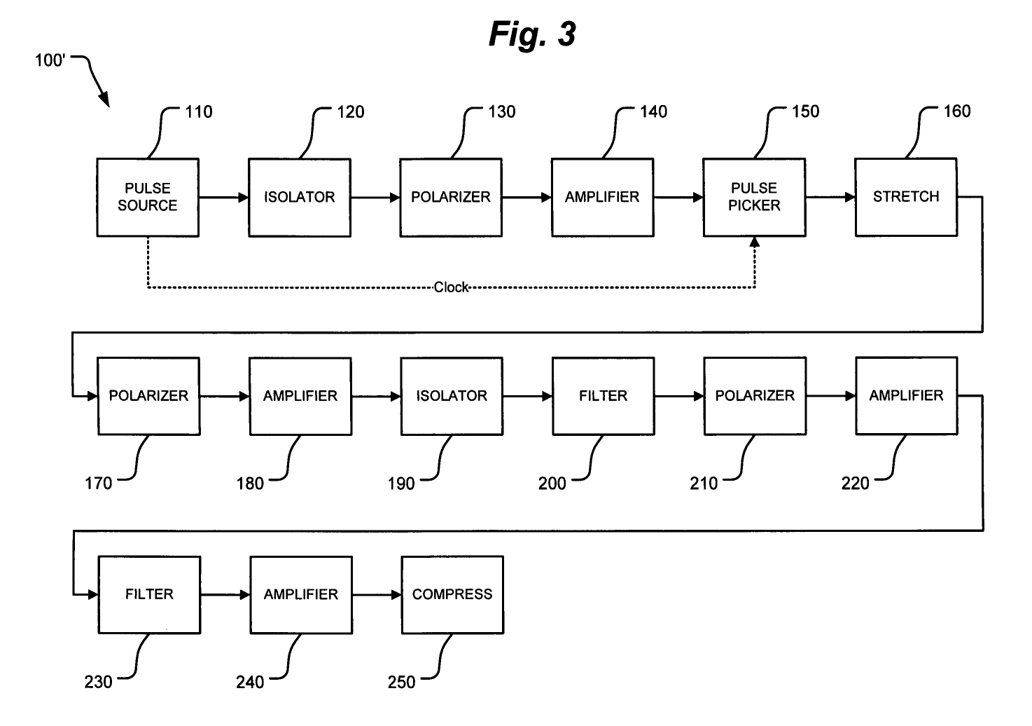

Referring now to FIG. 3, there is shown a block diagrammatic view of a system 100′ according to an aspect of the present invention. Like elements in systems 100 (FIG. 1) and 100′ (FIG. 3) have been identically labeled for clarity of discussion.

The illustrated system 100′ includes a pulse source 110. By way of non-limiting example only, pulse source 110 may take the form of a low-capacitance, curved-waveguide containing semiconductor source. Source 110 may incorporate two-section gain elements and angle-striped semiconductor optical amplifiers. Such a source is disclosed in co-pending U.S. patent application Ser. No. 10/859,553, entitled “COMPACT, HIGH-POWER, LOW-JITTER, SEMICONDUCTOR MODELOCKED LASER MODULE”, the entire disclosure of which is hereby incorporated by reference herein. Such a source may be packaged within standard sized butterfly packages utilizing lensed-tipped single-mode fiber, for example.

Source 110 may provide a high-power, low-jitter pulse train to an isolator 120. For example, the mode-locked laser (MLL) source 110 may provide 15 ps, 2 nm bandwidth pulses with a 1.5 GHz repetition rate. Isolator 120 may serve to prevent reflections from the remainder of system 100′ from adversely affecting source 110. Source 110 may be coupled to isolator 120 using polarization maintaining (PM), single-mode optical fiber, for example. Isolator 120 may take the form of a dual stage component providing greater than about 45 dB optical isolation. For example, isolator 120 may take the form of a commercially available Faraday isolator, such as model no. PDSI-2-56-P-1-4-L-1, which is available from Novawave Technologies.

Isolator 120 may feed a polarization control component 130. Polarizer 130 may be coupled to isolator 120 using polarization maintaining, single-mode optical fiber, for example. Polarizer 130 may serve to better ensure that the pulse-train provided by source 110 includes electromagnetic energy of a single polarization well-suited for amplification. Polarizer 130 may take the form of a commercially available polarizer, such as model no. PC100-15-F/A, which is commercially available from Fiberpro, for example. The polarized pulse-train may be provided to amplifier 140. Amplifier 140 may be coupled to polarizer 130 using polarization maintaining, single-mode optical fiber, for example.

Amplifier 140 may take the form of a semiconductor optical amplifier (SOA). SOA 140 may include a single-mode, ridge-guided structure operating at a center wavelength of about 1560 nm and having a bandwidth greater than about 20 nm, and introducing a small signal gain on the order of about 25 dB or more. Such a device may present a seeded, saturated output power greater than about 10 mW.

Amplifier 140 may be packaged in a form that allows insertion into transportable, fiberized, optical systems. The amplifier package may be of a 14-pin “butterfly” variety, containing thermoelectric (TE) based cooling and a Kovar mounting plate. The SOA and a thermistor for facilitating temperature control may be bonded to a patterned aluminum nitride submount, which is attached to the Kovar mounting plate. Lensed optical fiber may be attached to a Kovar clip and sub-micron aligned to SOA emission before being attached in place (via laser welding, for example). Thermal cycling/repositioning of fiber weld allows for rigid positioning of fiber lens tip with respect to the SOA. Wirebonds to package pin configurations allow for outside electrical connections to the hermetically sealed package.

Select ones of the amplified pulses output from amplifier 140 may be provided to a pulse temporal stretching device 160. For example, amplifier 140 may be coupled via a polarization maintaining, single-mode optical fiber to a pulse selector 150, in turn coupled via a polarization maintaining, single-mode optical fiber to temporal stretching device 160. Selector 150 may serve to down-convert the pulse repetition frequency of pulses provided by source 110 and amplified by amplifier 140, such as by selectively passing one out of every 1000 optical pulses received to stretching device 160.

By way of further non-limiting example, 15 ps, 2 nm bandwidth pulses with a 1.5 GHz repetition rate may be down-selected by selector 150 to a 1.5 MHz repetition rate using a LiNbO₃ modulator. A 1.5 MHz triggering signal for selectively picking amplified pulses to pass for stretching may be derived from the source 110 master 1.5 GHz signal, divided by a factor of 1000 using two trigger countdown circuits, for example. The lower repetition rate pulse-train allows for extraction of higher pulse energy from a 100 milli-watt (mW) class Erbium Doped Fiber Amplifier (EDFA), for example. Pulse selector 150 may take the form of a commercially available device, such as a device utilizing a high-speed Mach-Zehnder (MZ) modulator with pulsed-bias. For example, modulator model no. AZ-0k1-12-PFA-PFA-UL, which is commercially available from EOSpace and pulse bias source AVM-1-P which is commercially available from Avtech, may be used. As will be understood by those possessing an ordinary skill in the pertinent arts, due to the high repetition rate of pulse provide by source 110, pulse down-selection is performed prior to pulse stretching to mitigate the deleterious effects that would otherwise result from temporally adjacent pulses overlapping after stretching.

Stretching device 160 may take the form of a chirped, fiber Bragg grating (FBG). As is understood by those possessing an ordinary skill in the pertinent arts, Chirped Fiber Bragg Gratings (CFBG) are an extension of FBG commonly used to stabilize, and select a single optical tone from a laser. The grating “chirp” (controlled, linear increase or decrease in grating period) allows for reflection of a continuous band of wavelength. Due to the grating chirp, different wavelength components satisfy the Bragg condition at different points of propagation into the fiber grating. This results in a time delay of reflection of the various spectral-band components, such that an initially Fourier transform limited ultrashort pulse propagating into the CFBG results in an output pulse having a temporal spread in bandwidth, and a broadened, i.e., stretched output pulse. Characteristics of CFBG include degree of chirp linearity and uniformity of spectral reflection. Such a FBG has a dispersion of around 500 ps/nm, centered at 1563 nm with a 4 nm reflection band or greater. Where source 110 includes a harmonically mode locked laser (MLL), an intra-cavity tunable filter may be used to facilitate matching the MLL center wavelength and full bandwidth to the stretcher 160 FBG band. By way of further, non-limiting example only, the aforementioned down-selected 1.5 MHz pulses may be stretched to have durations of about 1.2 ns using FBG 160 in combination with optical circulators to separate input/output pulse streams. Following stretching, pulse energy may be on the order of about 0.1 pJ/pulse, for example.

Stretcher 160 may be coupled using a polarization maintaining, single-mode optical fiber to a polarizer 170. Like polarizer 130, polarizer 170 may serve to better ensure that the propagating pulse-train includes electromagnetic energy of a single polarization well-suited for further processing. Polarizer 130 may take the form of a commercially available polarizer, such as model no. PC1100-15-F/A, which is commercially available from Fiberpro, for example. The polarized pulse-train may be provided to an amplifier 180. Amplifier 180 may be coupled to polarizer 170 using polarization maintaining, single-mode optical fiber, for example.

Like amplifier 140, amplifier 180 may take the form of a packaged semiconductor optical amplifier (SOA). SOA 180 may include a single-mode, ridge-guided structure operating at a center wavelength of about 1560 nm and having a bandwidth greater than about 20 nm, and introducing a small signal gain on the order of about 25 dB or more. Such a device may present a seeded, saturated output power greater than about 10 mW. Amplifier 180 may be coupled via polarization maintaining, single-mode optical fiber to an isolator 190.

Like isolator 120, isolator 190 may serve to prevent reflections from the remainder of system 100′ from adversely affecting those elements discussed heretofore. Isolator 190 may take the form of a dual stage component providing greater than about 45 dB optical isolation. For example, isolator 190 may take the form of a commercially available Faraday isolator, such as model no. PDSI-2-56-P-1-4-L-1, which is available from Novawave Technologies Isolator 190 may be communicatively coupled to a filter 200 using polarization maintaining, single-mode optical fiber.

Filter 200 may take the form of a pass-band filter, for example. In the illustrated system 100′, filter 200 may provide for pass-band filtering on the order of 7-10 nm also centered at the source center wavelength. This may serve to remove ASE components and other optical noise components outside the band of interest that may adversely affect downstream amplifiers. Filter 200 may be communicatively coupled to a polarizer 210 using polarization maintaining, single-mode optical fiber. For example, model no. TF-11-11-1555/1565-9/125-S-40-3A3A-1-7-SP-CSP, which is commercially available from Oz Optics may be used.

Like polarizer 130, polarizer 210 may serve to better ensure that the propagating pulse-train includes electromagnetic energy of a single polarization well-suited for further processing Polarizer 130 may take the form of a commercially available polarizer, such as model no. PC1100-15-F/A, which is commercially available from Fiberpro, for example The polarized pulse-train may be provided to amplifier 220 using polarization maintaining, single-mode optical fiber, for example.

Like amplifiers 140, 180, amplifier 220 may take the form of a packaged semiconductor optical amplifier (SOA). SOA 220 may include a single-mode, ridge-guided structure operating at a center wavelength of about 1560 nm and having a bandwidth greater than about 20 nm, and introducing a small signal gain on the order of about 25 dB or more. Such a device may present a seeded, saturated output power greater than about 10 mW.

Commercial current pulsers delivering 800 mA, 12 ns drive pulses may be used to drive amplifiers 140, 180 and/or 220. Of course, other current pulser schemes may be used though. The current pulsers provide drive pulses being temporally synchronized with the stretched optical pulses such that the SOA amplifiers are powered only during the times that pulse amplification is intended to occur, i.e., to coincide with the arrival of the low duty cycle stretched optical pulse stream.

Amplifier 220 may be communicatively coupled to a pass-band filter 230 using polarization maintaining, single-mode optical fiber. Like filter 200, filter 230 may provide for pass-band filtering on the order of 7-10 nm also centered at the source center wavelength. This may serve to remove ASE components and other optical noise components outside the band of interest that may adversely affect downstream amplifiers. For example, model no. TF-11-11-1555/1565-9/125-S-40-3A3A-1-7-SP-CSP, which is commercially available from Oz Optics may be used.

Thus, according to an aspect of the present invention, the stretched pulse may be amplified in two packaged, cascaded pulse-bias SOA amplifiers 180, 220. This amplification may be to around a level of about 20 pJ/pulse (as opposed to the 0.1 pJ/pulse energy provided by stretcher 160). Pulse-biasing and pass band optical filtering may mitigate background amplified spontaneous emissions (ASE), that may otherwise deteriorate system performance.

According to an aspect of the present invention, the filtered output from filter 230 may be provided via polarization maintaining, single-mode optical fiber to an amplifier 240 for further amplification. Amplifier 240 may take the form of a 10 mW class EDFA. Due to low duty cycle, 10 mW average power produces pulses with nanojoules of energy. EDFA 240 may take the form of a pre-amplification amplifier and power amplifier. EDFA 240 may provide amplification on the order of greater than about 30 dB and seeded, saturation powers greater than 10 mW, such as up to about 400 mW or more.

Amplifier 240 may be communicatively coupled via polarization maintaining, single-mode optical fiber to an FBG compressor 250. Compressor 250 may be a matching compressor for stretcher 160, i.e. similarly fabricated CFBG operated such as to provide the opposite pulse dispersion—so as to remove the temporal effects introduced by stretcher 150. As will be understood by those possessing an ordinary skill in the pertinent arts, with access to both fiber ends, a single CFBG may be utilized as both the stretcher and compressor. However, due to out of band optical power coupling, independent CFBG may be desirable.

Following re-compression by compressor 250, 50 ps, 7 nJ/pulse (11 mW average power) may be obtainable, limited by EDFA 240 ASE, for example. Increased seed energy or mid-span EDFA filtering may optionally be used to achieve higher pulse energy extraction from EDFA 240, for example.

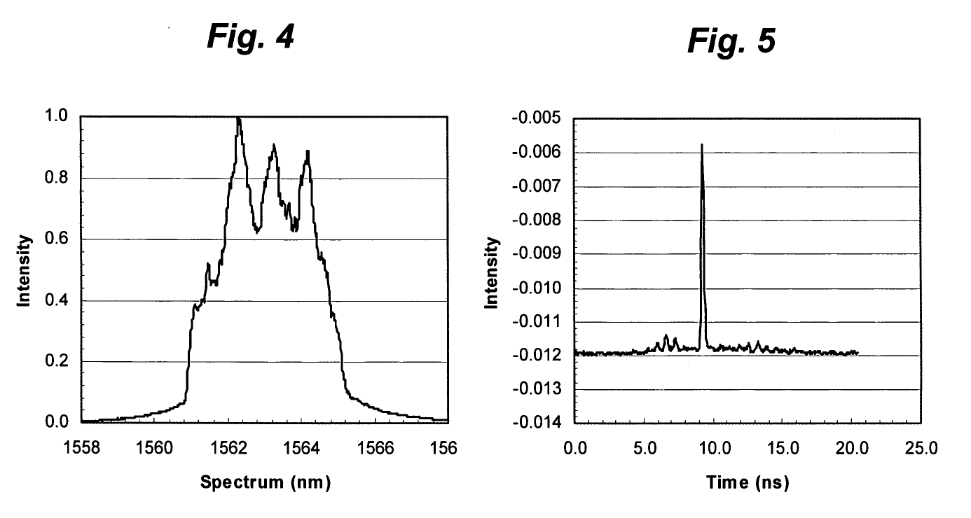

Referring now to FIG. 4, there is shown a pulse spectrum after EDFA amplification and FBG compression. Referring now to FIG. 5, there is shown a sampling scope profile after EDFA amplification and FBG compression. As may be ascertained therefrom, according to an aspect of the present invention a coherent (i.e., compressible) broadband signal may be provided. As will be appreciated by those possessing an ordinary skill in the art, bandwidth of the MLL source is preserved.

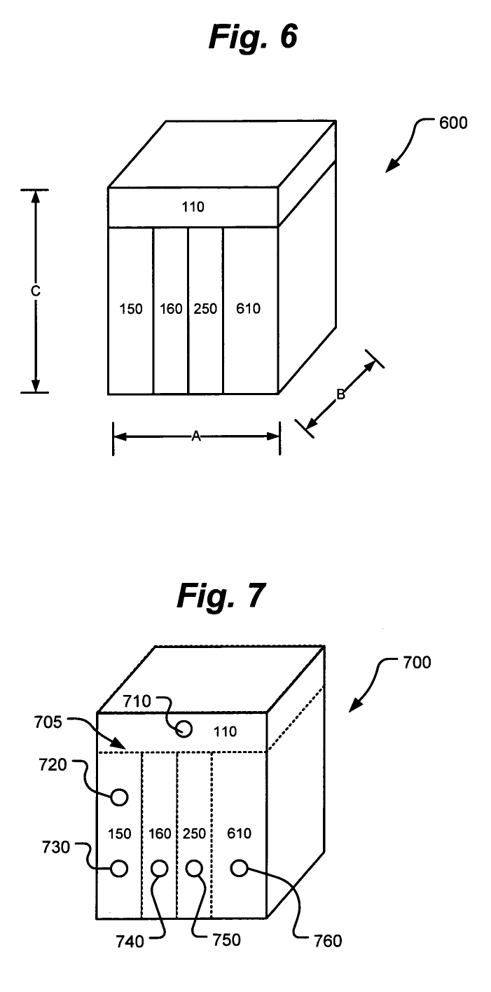

Referring now to FIG. 6, there is shown a configuration 600 according to an aspect of the present invention. Configuration 600 may include each of the elements illustrated in and discussed with regard to FIG. 3. For example, configuration 600 may include a source 110, pulse selector 150, FBG stretcher 160 and FBG compressor 250 in the illustrated relative positions. The other elements of FIG. 3 may be positioned in a polarization, filtering and amplification region 610. Configuration 600 may be well suited for being placed within an enclosure. By way of non-limiting example only, configuration 600 may be suitable for being placed in an enclosure measuring about 7 inches (dimension A)×about 13.375 inches (dimension B)×about 13 inches (dimension C).

Referring now to FIG. 7, there is shown a compact and portable source device 700 according to an aspect of the present invention. Device 700 may incorporate configuration 600 of FIG. 6, and hence system 100′ of FIG. 3, for example. Device 700 may include a panel 705, that provides fiber outputs (e.g., monitor taps for system diagnostics) 710-760. Tap 710 may provide a signal associated with source 110 (e.g., signal 115, FIG. 2). Tap 720 may provide an output associated with pulse selector 150 (e.g., a signal tapped from between isolator 120 and polarizer 130). Tap 730 may also provide an output associated with pulse selector 150 (e.g., a signal tapped from between selector 150 and stretcher 160, e.g., signal 155 of FIG. 2). Tap 740 may provide an output associated with FBG stretcher 160 (e.g., signal 165, FIG. 2). Tap 750 may provide an output associated with compressor 250 (e.g., a system output or a signal tapped before or after compressor 250). Tap 760 may provide an output associated with amplifiers 180, 220 (e.g., a signal tapped from between filter 200 and polarizer 210).

Another panel (not shown), such as a panel being oppositely disposed from panel 705, may provide electrical connections for the elements of system 600. Such a compact CPA mode locked laser system incorporating packaged semiconductor gain elements may be used to produce 7 nJ, 50 ps output pulses at a 1.5 MHz repetition rate, for example.

It will be apparent to those skilled in the art that various modifications and variations may be made in the apparatus and process of the present invention without departing from the spirit or scope of the invention. Thus, it is intended that the present invention cover the modification and variations of this invention provided they come within the scope of the appended claims and their equivalents.

1. A compact signal source comprising:
a semiconductor-based, pulsed optical energy source for providing a series of pulses at a given frequency;
a selector being optical fiber coupled to said pulsed optical energy source and for down-selecting said pulses to a lower frequency;
a stretcher being optical fiber coupled to said selector and for temporally stretching said selected pulses;
at least one semiconductor-based optical amplifier being optical fiber coupled to said stretcher and for amplifying said selected pulses;
a compressor being optical fiber coupled to said at least one semiconductor-based amplifier and for temporally compressing said amplified, stretched, selected pulses; and,
a portable housing containing said pulsed optical energy source, stretcher, at least one semiconductor-based optical amplifier and compressor.

2. The source of claim 1, wherein said at least one semiconductor-based amplifier comprises at least two semiconductor-based amplifiers.

3. The source of claim 1, further comprising at least one Erbium Doped Fiber Amplifier optically interposed between said stretcher and compressor.

4. The source of claim 1, wherein each of said stretcher and compressor comprise a chirped fiber Bragg grating.

5. The source of claim 1, wherein said given frequency is greater than about 1 GHz.

6. The source of claim 1, further comprising an isolator optically interposed between said pulsed optical energy source and said selector.

7. The source of claim 6, further comprising another semiconductor based amplifier optically interposed between said pulsed optical energy source and said selector.

8. The source of claim 7, further comprising a polarization dependent device optically interposed between said pulsed optical energy source and said selector.

9. The source of claim 1, further comprising a polarization dependent device optically interposed between said stretcher and said at least one semiconductor-based optical amplifier.

10. The source of claim 1, further comprising an isolator optically interposed between said at least one semiconductor-based optical amplifier and said compressor.

11. The source of claim 10, further comprising another semiconductor-based optical amplifier optically interposed between said at least one semiconductor-based optical amplifier and said compressor.

12. The source of claim 11, further comprising a polarization dependent device optically interposed between said at least one semiconductor-based optical amplifier and said compressor.

13. The source of claim 11, further comprising a plurality of pass-band filters, each being optically coupled to a corresponding one of said semiconductor-based optical amplifiers.

14. The source of claim 1, wherein said housing has an interior volume less than about 1500 in³.

15. A method for providing at least high energy, high-frequency, short duration optical pulses using a compact device, said method comprising:
generating a series of short duration optical pulses at a frequency greater than about 1 GHz;
down-converting said pulses to said high-frequency;
temporally stretching said down-converted pulses;
amplifying said stretched, down-converted pulses using a semiconductor-based gain-medium;
temporally compressing said amplified pulses at said high-frequency; and,
fiber coupling said short duration optical pulses at a frequency greater than about 1 GHz, said down-converted pulses, said stretched pulses and said amplified pulses.

16. The method of claim 15, further comprising further amplifying said amplified pulses at said high-frequency using at least one Erbium Doped Fiber Amplifier.

17. The method of claim 15, wherein said given frequency is greater than about 1 GHz.

18. The method of claim 15, further comprising optically isolating a source of said pico-second optical pulses at a given frequency from reflections.

19. The method of claim 15, further comprising fiber coupling said pulses.
